(19) United States
(12) Patent Application Publication
(10) Pub. No.: US 2006/0001592 A1
(43) Pub. Date: Jan. 5, 2006

(54) Folded monopole antenna

(76) Inventor: Eung-Soon Chang, Seoul (KR)

Correspondence Address: COLEMAN SUDOL SAPONE, P.C., 714 COLORADO AVENUE, BRIDGE PORT, CT, 06605-1601, US

(21) Appl. No.: 10/530,212

(22) PCT Filed: Dec. 24, 2002
(86) PCT No.: PCT/KR02/02422

§ 371 Date: Aug. 12, 2005

(30) Foreign Application Priority Data
Nov. 13, 2002 (KR) 2002/70497

(51) Int. Cl. H01Q 1/36

(52) U.S. Cl. 343/895; 343/702

(57) ABSTRACT

The present invention relates to a folded monopole antenna which includes an antenna pattern in which an impedance is decreased to a metal itself resistance based on a feeding point which is provided in an upper portion of a wireless instrument and is continuously extended in a linear shape having a certain thickness and is formed in an upward direction for thereby forming a value L, and an offset point which is provided near the feeding point for thereby forming a value C, and an antenna casing which protects and insulates the antenna pattern. In the present invention, it is possible to obtain a lower gain compared to a conventional helical antenna, and a value Q is largely enhanced.

### TECHNICAL FIELD

The present invention relates to a monopole antenna, and in particular to an improved folded monopole antenna which obtains a feeding point which is upwardly defined to have a value L and an off-set point which is in parallel with a portion near a feeding point for forming a value C, so that it is possible to decrease an impedance based on a metal self-resistance and implement a direct medium of a signal transmission and receiving operation of a wireless instrument.

### BACKGROUND ART

Generally, a conventional wireless communication apparatus like a cellular phone is adapted to use a monopole antenna for transmitting and receiving an electrical signal. The conventional cellular monopole antenna is formed of a tube type antenna device which is grounded to a casing of a cellular phone, and a metal rod which is disposed in the interior of the grounded tube type antenna device. In order to obtain a large gain and bandwidth characteristic which are required for a cellular communication must signed to be longer than the length of a casing of a known cellular phone. Since the long cellular phone antenna limits a portability of a cellular phone, when the cellular phone is not, the monopole antenna is designed in a monopole antenna section of a telescoping method in which the monopole antenna is folded in the casing.

However, the monopole antenna must be designed to extend for achieving a certain gain and bandwidth characteristic which are required in a cellular communication. Therefore, many studies are performed for decreasing the length and volume of a monopole antenna without affecting an antenna gain and bandwidth.

### DETAILED DESCRIPTION OF THE PRESENT INVENTION

Accordingly, it is a prime object of the present invention to provide a folded monopole antenna which overcomes the problems encountered in the conventional art.

It is another object of the present invention to provide a folded nonopole antenna which is capable of implementing a slim type design without decreasing an inherent performance of a system and obtaining an enhanced performance compared to a conventional helical antenna or conventional common antenna.

In order to achieve the above objects, there is provided a folded monopole antenna which includes an antenna pattern in which an impedance is decreased to a metal itself resistance based on a feeding point which is provided in an upper portion of a wireless instrument and is continuously extended in a linear shape having a certain thickness and is formed in an upward direction for thereby forming a value L, and an offset point which is provided near the feeding point for thereby forming a value C, and an antenna casing which protects and insulates the antenna pattern.

### BRIEF DESCRIPTION OF THE DRAWINGS

The present invention will become better understood with reference to the accompanying drawings which are given only by way of illustration and thus are not limitative of the present invention, wherein;

FIG. 1 is a perspective view illustrating a cellular phone for describing a folded monopole antenna according to the present invention;

FIG. 2 is a perspective view illustrating a pattern of a monopole antenna according to a first embodiment of the present invention;

FIG. 3 is a perspective view illustrating a pattern of a monopole antenna according to a second embodiment of the present invention;

FIG. 4 is a perspective view illustrating a pattern of a monopole antenna according to a third embodiment of the present invention;

FIG. 5 is a perspective view illustrating a pattern of a monopole antenna according to a fourth embodiment of the present invention;

FIG. 6 is a graph illustrating a network data of a known helical antenna;

FIG. 7 is a graph illustrating a radiating data of a known helical antenna;

FIG. 8 is a graph illustrating a SAR measurement value of a known helical antenna;

FIG. 9 is a graph illustrating a network data of a first antenna pattern according to the present invention;

FIG. 10 is a graph illustrating a radiating data of a first antenna pattern according to the present invention;

FIG. 11 is a graph illustrating a SAR measurement value of a first antenna pattern according to the present invention;

FIG. 12 is a graph illustrating a network data of a second antenna pattern according to the present invention;

FIG. 13 is a graph illustrating a radiating data of a second antenna pattern according to the present invention; and

FIG. 14 is a graph illustrating a SAR measurement value of a second antenna pattern according to the present invention.

### DESCRIPTIONS OF REFERENCE NUMERALS CONCERNING MAJOR ELEMENTS OF THE DRAWINGS

| | | | |
|---|---|---|---|
| 10: | cellular phone | 12: | monopole antenna |
| 12a: | antenna pattern | 14: | cellular phone body |

### PREFERRED EMBODIMENTS OF THE PRESENT INVENTION

The preferred embodiments of the present invention will be described with reference to the accompanying drawings.

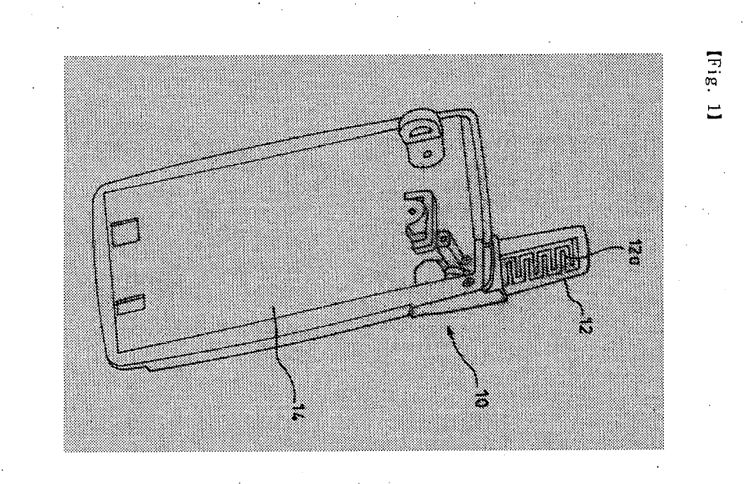

FIG. 1 is a rear perspective view illustrating the construction in which a folded monopole antenna is engaged in a cellular phone. The antenna 10 includes a folded monopole antenna 12 which is a certain medium for transmitting and receiving an electrical signal therethrough, a cellular phone body 14 for implementing a wireless transmission and receiving operation of an electrical signal, and a battery(not shown) for supplying a power for driving the cellular phone. Here, since the battery is not directly related with the present invention, the detailed description thereon will be omitted.

An antenna pattern 12a which is provided in the interior of the folded monopole antenna 12 and is formed of a conductive metallic material for thereby implementing a direct wireless transmission and receiving operation of an electrical signal includes a certain thickness and is formed in such a manner that it is bent by a few times regularly on the plane.

The above antenna pattern 12a may be implemented in various shapes as follows.

### The First Embodiment

In the first embodiment of the present invention, the antenna pattern is formed in a rectangular shape and is bent by a few times in a direction of center of the same on the plane.

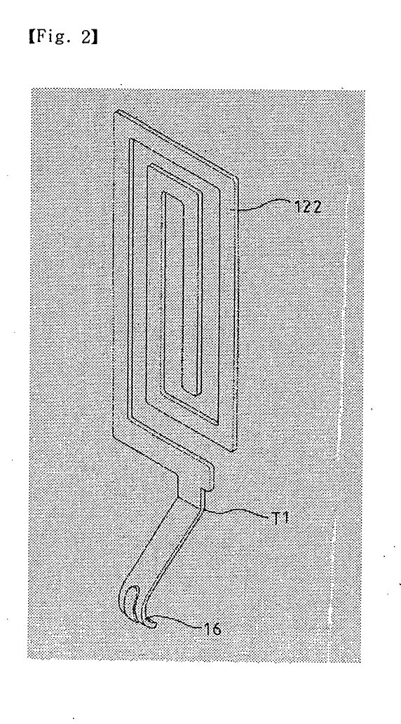

FIG. 2 is a view illustrating an antenna pattern of a folded monopole antenna according to a first embodiment of the present invention. As shown therein, the first antenna pattern 122 is formed in a rectangular shape and is bent by a few times in a direction of center of the same on the plane and is formed of a first point T1 which is bent in a lower portion at a certain angle in such a manner that the first portion T1 is a rectangular shape and is bent by a few times in a direction of center on the plane, and a fixing portion 16 for fixing to an upper portion of the cellular phone body 14.

### The Second Embodiment

In the second embodiment of the present invention, the antenna pattern is formed in a rectangular shape and is formed repeatedly in a longitudinal direction by a few times in the rectangular shape.

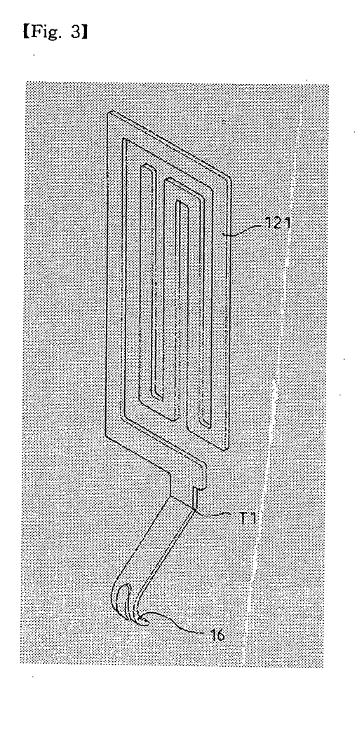

FIG. 3 is a view illustrating an antenna pattern of a folded monopole antenna according to a second embodiment of the present invention. The second antenna pattern 21 is formed in a rectangular shape and is formed repeatedly in a longitudinal direction by a few times in the rectangular shape and includes a first point T1 which is bent in a lower portion at a certain angle, and a fixing portion 16 for fixing to an upper portion of the cellular phone body 14.

### The Third Embodiment

In the third embodiment of the present invention, the antenna pattern is extended in a longitudinal direction by a certain distance and then is bent in a certain direction and is reciprocate-formed in the left and right directions on the plane, and a left portion of the same is bent at 90°.

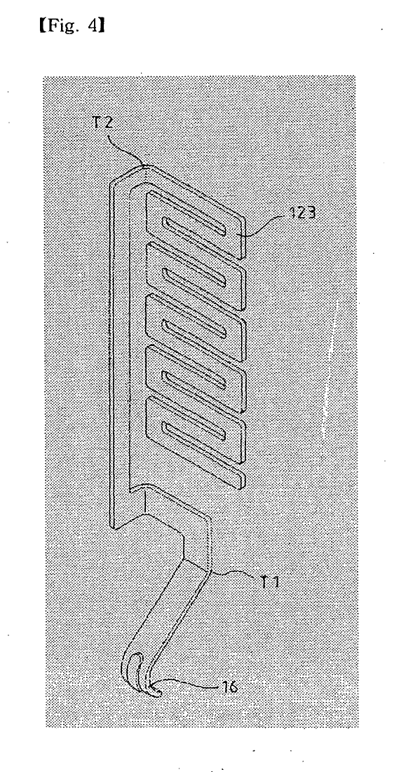

FIG. 4 is a view illustrating an antenna pattern of a folded monopole antenna according to a third embodiment of the present invention. As shown therein, a third antenna pattern 123 is formed in a rectangular shape and downwardly reciprocates in a longitudinal direction by a few times in the interior of the rectangular shape and includes a second point T2 of which a part of the left portion is bent at 90° differently from the other portions, a first point TY1 which is bent in a lower portion at a certain angle, and a fixing portion 16 for fixing to an upper portion of the cellular phone body 14.

### The Fourth Embodiment

In the fourth embodiment of the present invention, an antenna pattern does not form a second point T2 of the third embodiment of the present invention.

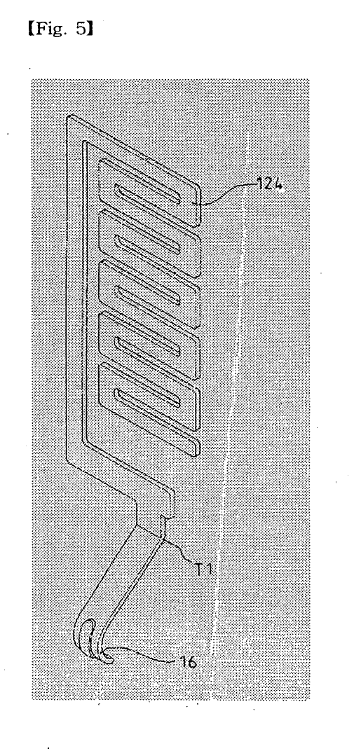

FIG. 5 is a view illustrating an antenna pattern of a folded monopole antenna according to a fourth embodiment of the present invention. As shown therein, the fourth antenna pattern 124 is generally formed in a rectangular shape and downwardly reciprocates in the left and right directions in a longitudinal direction in the interior of the rectangular shape and includes a first point T1 which is bent in a lower portion at a certain angle and a fixing portion 16 for fixing to an upper portion of the cellular phone body 14.

The operation and effects of the present invention will be described based on a result of the test with respect to a conventional helical antenna.

First, an antenna pattern according to the present invention and a conventional helical antenna were sampled, and the test was conducted in EM Lab of Sunchunhyang University.

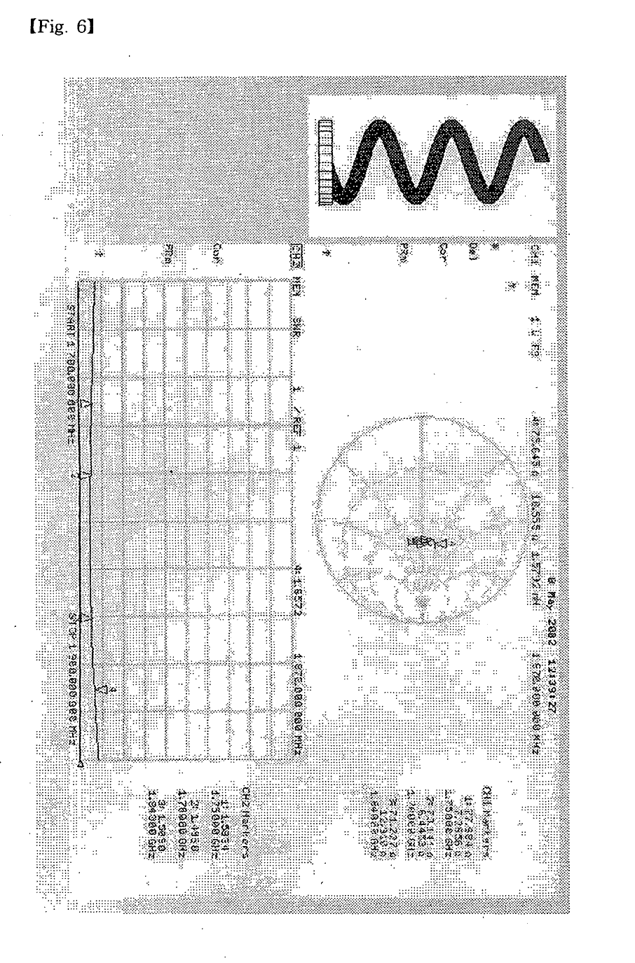

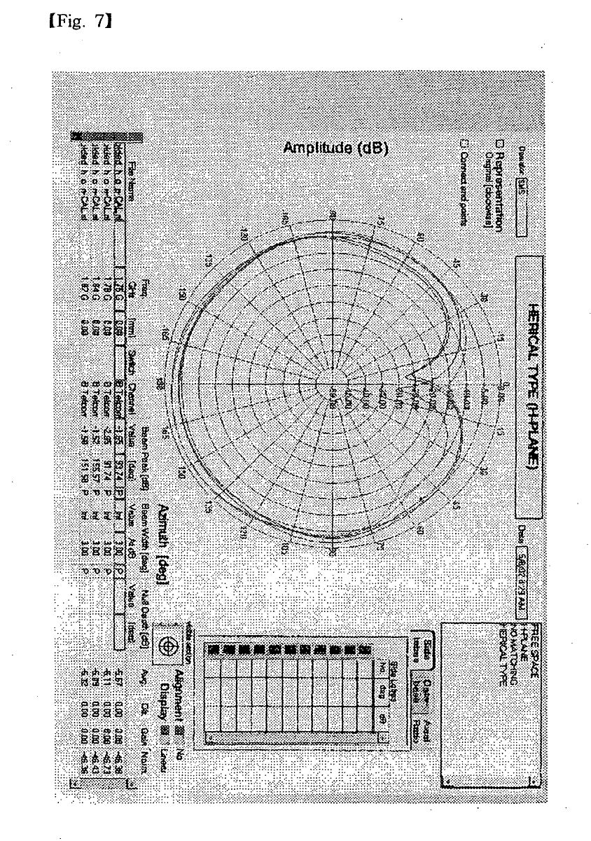

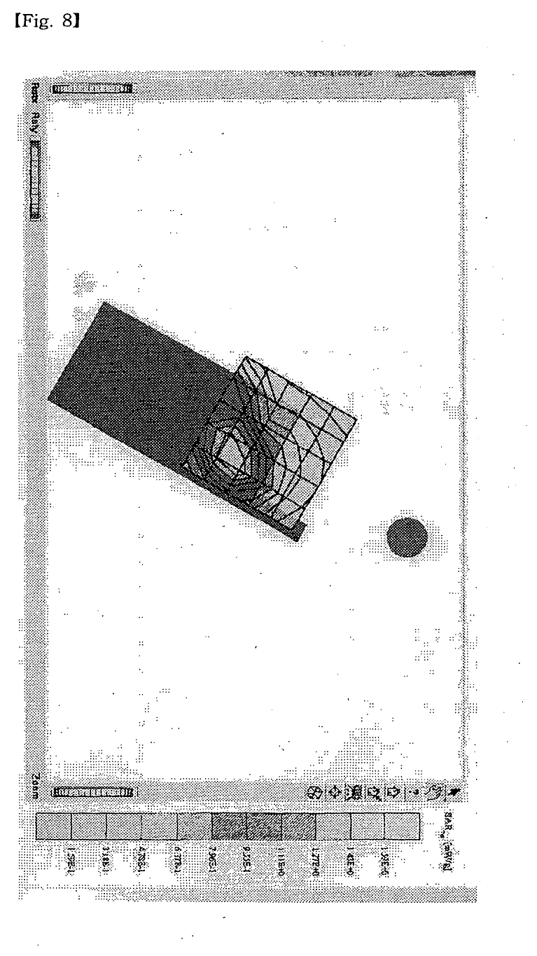

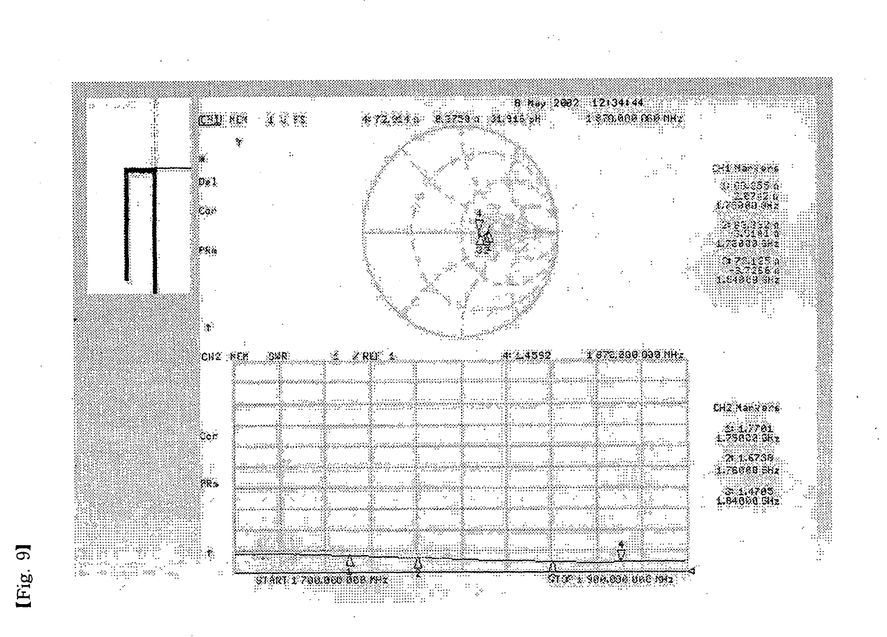

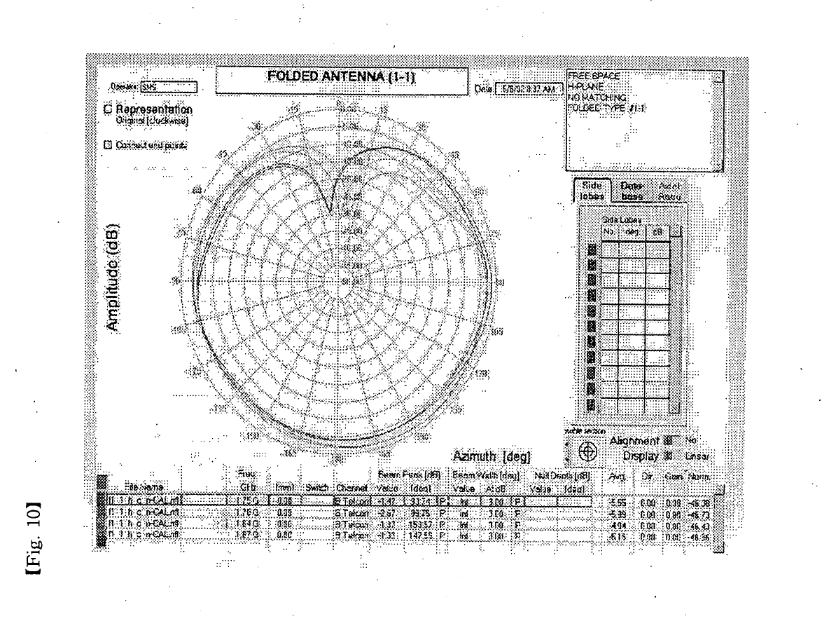

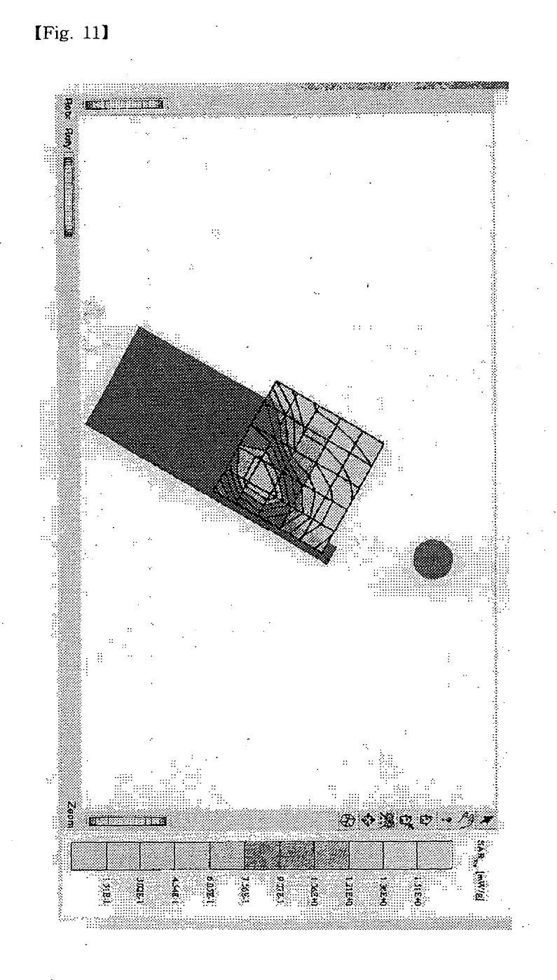

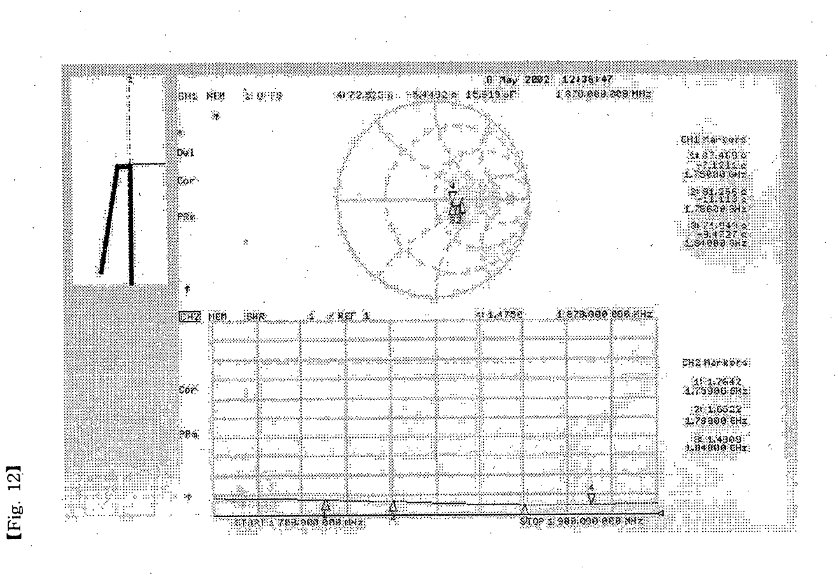

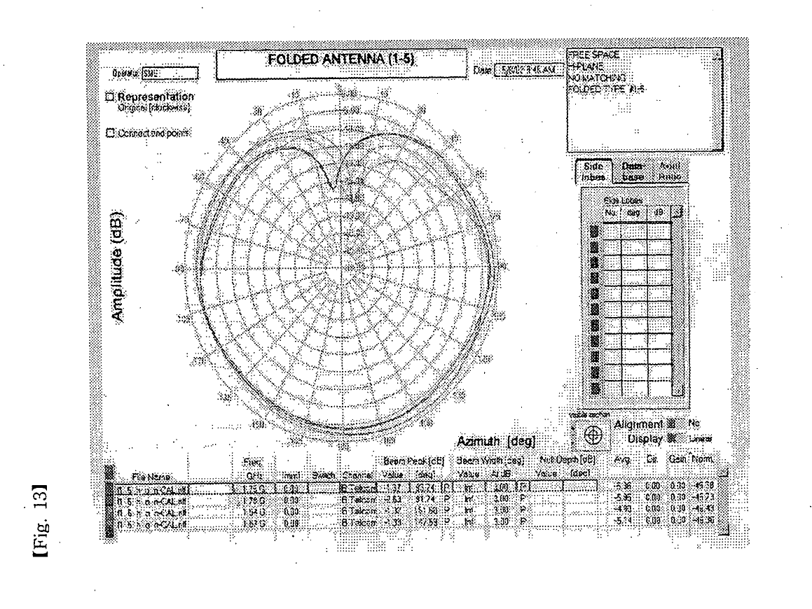

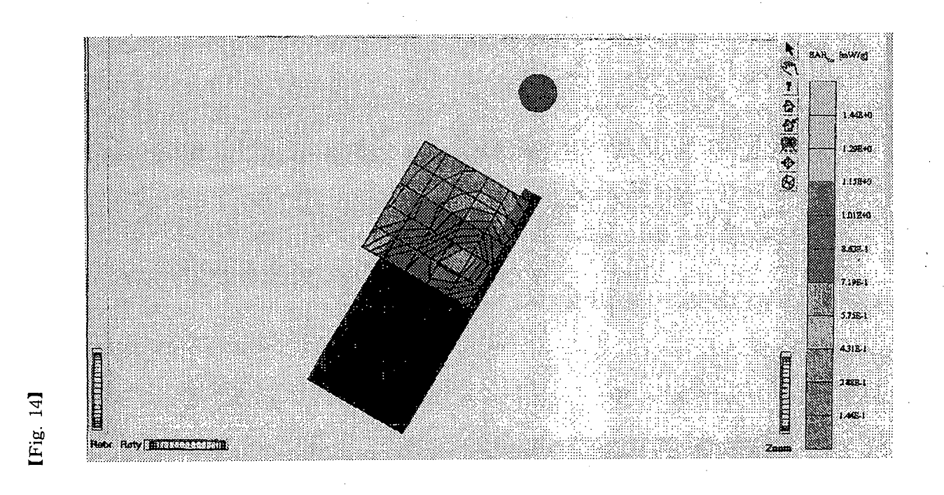

FIG. 6 is a graph illustrating a network data of a known helical antenna, FIG. 7 is a graph illustrating a radiating data of a known helical antenna, FIG. 8 is a graph illustrating a SAR measurement value of a known helical antenna, FIG. 9 is a graph illustrating a network data of a first antenna pattern according to the present invention, FIG. 10 is a graph illustrating a radiating data of a first antenna pattern according to the present invention, FIG. 11 is a graph illustrating a SAR measurement value of a first antenna pattern according to the present invention, FIG. 12 is a graph illustrating a network data of a second antenna pattern according to the present invention, FIG. 13 is a graph illustrating a radiating data of a second antenna pattern according to the present invention, and FIG. 14 is a graph illustrating a SAR measurement value of a second antenna pattern according to the present invention.

For reference, the network data is adapted for measuring a receiving ratio of a wireless instrument at a certain angle, and the radiating data is adapted to measure whether a wireless signal is effectively received at a certain angle, and the SAR data is adapted to measure an electromagnetic interference which affects a human body by a wireless instrument.

In addition, in the present invention, the feeding point forms the value L, and the off-set point forms the value C, and the values L and C are offset each other, so that the impedance is decreased to a metal itself resistance, whereby it is possible to implement an excellent communication environment.

As shown therein, it was known that the folded monopole antenna according to the present invention was excellent compared to a conventional helical antenna in the point of the network data. In the point of the radiating data, the average amplitude of the conventional helical antenna was −5.67, −6.11, −5.09, −5.32, and the first antenna pattern according to the present invention was −5.55, −5.99, −4.94, −5.15, and the second antenna pattern of the present invention was −5.36, −5.85, −4.90, −5.14. Namely, the second antenna pattern was best, the first antenna pattern was the middle, and the conventional helical antenna was worst. In addition, in the point of the SAR measurement values, the folded monopole antenna of the present invention was better compared to the conventional helical antenna.

### INDUSTRIAL APPLICATABILITY OF THE INVENTION

The effects of the present invention will be described.

First, in the present invention, it is possible to fabricate a slim type antenna without a performance decrease by overcoming a design limit with respect to an antenna used in a conventional wireless instrument.

Second, in the present invention, the feeding point forms the value L, the offset point forms the value C, and the values L and C are offset each other, so that the impedance is decreased to a metal itself resistance for thereby implementing an excellent communication environment.

Third, an antenna protruded portion of the cellular phone is minimized, and an excellent convenience is implemented. In addition, the cellular phone is assembled in a snap-in method, it is easy to fabricate the cellular phone.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A folded monopole antenna, comprising:
an antenna pattern in which an impedance is decreased to a metal itself resistance based on a feeding point which is provided in an upper portion of a wireless instrument and is continuously extended in a linear shape having a certain thickness and is formed in an upward direction for thereby forming a value L, and an offset point which is provided near the feeding point for thereby forming a value C; and
an antenna casing which protects and insulates the antenna pattern.

2. The antenna of claim 1, wherein said antenna pattern is generally formed in a rectangular shape and reciprocates in a longitudinal direction by a few times in the interior of a rectangular shape.

3. The antenna of claim 1, wherein said antenna pattern is extended in a longitudinal- direction by a certain distance and is bent in a certain direction and downwardly reciprocates in the left and right directions, and a part of the left portion on the plane is bent at an angle of 90°.

4. The antenna of claim 1, wherein said antenna pattern is extended in a longitudinal direction and is bent in a certain direction and is extended by a certain distance and downwardly reciprocates in the left and right directions.

5. The antenna of claim 1, wherein said antenna pattern is generally rectangular and is bent in a direction of the center by a few times on the plane.
